(19) United States
(12) Patent Application Publication
(10) Pub. No.: US 2024/0295639 A1
(43) Pub. Date: Sep. 5, 2024

(54) HYBRID TWO-DIMENSIONAL STEERING LIDAR

(71) Applicant: Voyant Photonics, Inc., New York, NY (US)

(72) Inventors: Christopher T. PHARE, New York, NY (US); Sajan SHRESTHA, New York, NY (US)

(21) Appl. No.: 18/663,688

(22) Filed: May 14, 2024

Related U.S. Application Data
(63) Continuation-in-part of application No. 17/002,901, filed on Aug. 26, 2020.

(51) Int. Cl. G01S 7/481

(52) U.S. Cl. CPC G01S 7/4817

(57) ABSTRACT

An optical emitter device includes an emitter array comprising a plurality of end-fire tapers, each end-fire taper configured to selectively emit a respective beam of light. A lens system is configured to shape and direct each beam of light based on a position of the respective end-fire taper relative to an optical axis of the lens system. A rotating reflector, including an axis of rotation perpendicular to the optical axis of the lens system, is configured to redirect and scan the beams of light through a scanning range.

### CROSS-REFERENCE TO RELATED APPLICATIONS

This application is a continuation-in-part of U.S. patent application Ser. No. 17/002,901, filed on Aug. 26, 2020. The above application is hereby incorporated by reference herein in its entirety.

### TECHNICAL FIELD

The present disclosure relates to an optical emitter device, and in particular to an optical emitter device used in a light detection and ranging (LIDAR) system.

### BACKGROUND

On-chip photonics may easily integrate components such as lasers, detectors, and switches with compactness and low cost; however, to achieve beamforming and two-dimensional beam-steering, on-chip photonics consume a great deal of power and can be architecturally complex. On the other hand, using free space optics, e.g. lenses and mirrors, may be architecturally simple and power efficient for beamforming, and beam-steering, but other discrete components, such as lasers, receivers, and switches, are bulky and more expensive than their on-chip counterparts. With demanding applications that require very high resolution, or points per second, the aforementioned problems lead to either bulky and costly LIDAR systems made entirely of free space elements, i.e. multiple lasers, detectors, and switches, or power hungry, limited field-of-view, and low signal-to-noise ratio (SNR) lidar systems made with pure integrated photonics, e.g. an optical-phased-array. The present disclosure describes a low cost and compact hybrid lidar system architecture, in which the best of the two worlds are combined, where the photonics chip integrates the laser, detector, and switches, and the free space optics, e.g. mirror and lenses, are used for the beam-steering and beamforming.

Slow response times of thermo-optic switches used in on-chip photonics are a significant limiting factor in achieving ultrafast optical beam steering. On-chip optical phased arrays (OPA) also suffer from high insertion loss that results in high power consumption, low frame rate, and low signal-to-noise ratio.

One dimensional OPAs also require wavelength tuning to steer the beam in two dimensions. The wavelength tuning range is typically in the tens or hundreds of nanometers to get a field-of-view (FOV) more than 30°. However, wide bandwidth tunable lasers with narrow linewidth (for FMCW lidar) are difficult to design and fabricate.

### SUMMARY

Accordingly, a first apparatus includes an optical emitter device comprising: an emitter array comprising a plurality of point emitters, each respective point emitter configured to emit a respective beam of output light, and configured to receive a respective beam of input light; a lens system configured to shape and direct each respective beam of output light and each respective beam of input light based on a position of each respective point emitter relative to an optical axis of the lens system; and a rotating reflector located at the aperture stop of the lens system configured to redirect each respective beam of output light outwardly at an angle to the optical axis, and configured to redirect each respective beam of input light towards the emitter array.

### BRIEF DESCRIPTION OF THE DRAWINGS

Some example embodiments will be described in greater detail with reference to the accompanying drawings, wherein:

FIG. 1 is an top view in accordance with an example embodiment of the present disclosure;

FIG. 2A is a side view of the device of FIG. 1 with the rotating mirror in a first position;

FIG. 2B is a side view of the device of FIG. 1 with the rotating mirror in a second position;

FIG. 3A is a top view of a portion of the optical emitter chip the device of FIG. 1;

FIG. 3B is a top view of a portion of another exemplary embodiment of the optical emitter chip the device of FIG. 1;

FIG. 3C is a top view of a portion of another exemplary embodiment of the optical emitter chip the device of FIG. 1;

FIG. 3D is a top view of a portion of another exemplary embodiment of the optical emitter chip the device of FIG. 1;

FIG. 4 is a cross sectional view of an exemplary optical emitter chip of the device of FIG. 1;

FIG. 5 is a cross sectional view of another exemplary optical emitter chip of the device of FIG. 1;

FIG. 6 is a top view of the optical emitter chip of the device of FIG. 5;

FIG. 7 is a top view in accordance with an example embodiment of the present disclosure;

FIG. 8 is a side view of the device of FIG. 4;

FIG. 9 is a side view of another example embodiment of the present disclosure;

FIG. 10 is a top view in accordance with an example embodiment of the present disclosure illustrating alternative positions for the mirror;

FIG. 11A is a side view of an example polygonal mirror embodiment during normal operation;

FIG. 11B is a side view of an example polygonal mirror embodiment during dead time operation;

FIG. 12A is a side view of an example galvo mirror embodiment;

FIG. 12B is a graphical representation of an example scanning motion imparted to a galvo mirror of an embodiment such as that of FIG. 12A;

FIG. 13A is an illustration depicting an example nonuniform vertical and horizontal scan pattern according to an embodiment;

FIG. 13B is a graphical representation of an example scanning motion imparted to a galvo mirror of an embodiment generating a scan pattern such as that of FIG. 13A;

FIG. 14A is a graphical representation of an example vertical and horizontal scan pattern according to an embodiment utilizing the emitter chip as the fast-axis; and

FIG. 14B is a graphical representation of an example vertical and horizontal scan pattern according to an embodiment utilizing the emitter chip as the slow-axis.

### DETAILED DESCRIPTION

While the present teachings are described in conjunction with various embodiments and examples, it is not intended that the present teachings be limited to such embodiments. On the contrary, the present teachings encompass various alternatives and equivalents, as will be appreciated by those of skill in the art.

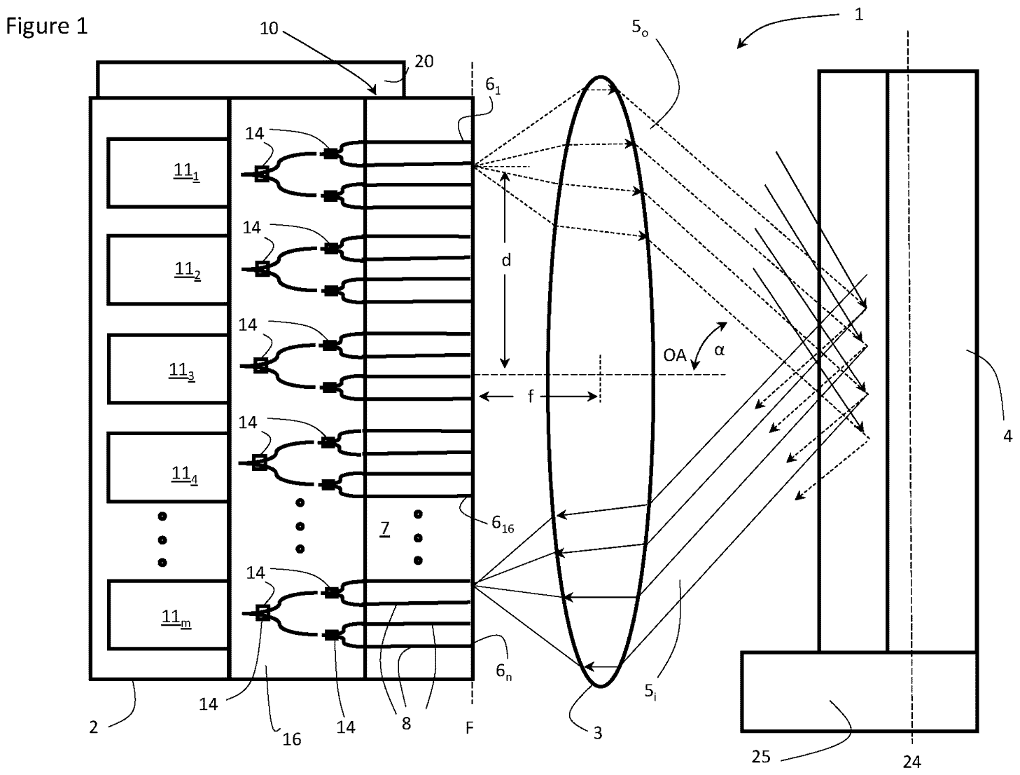

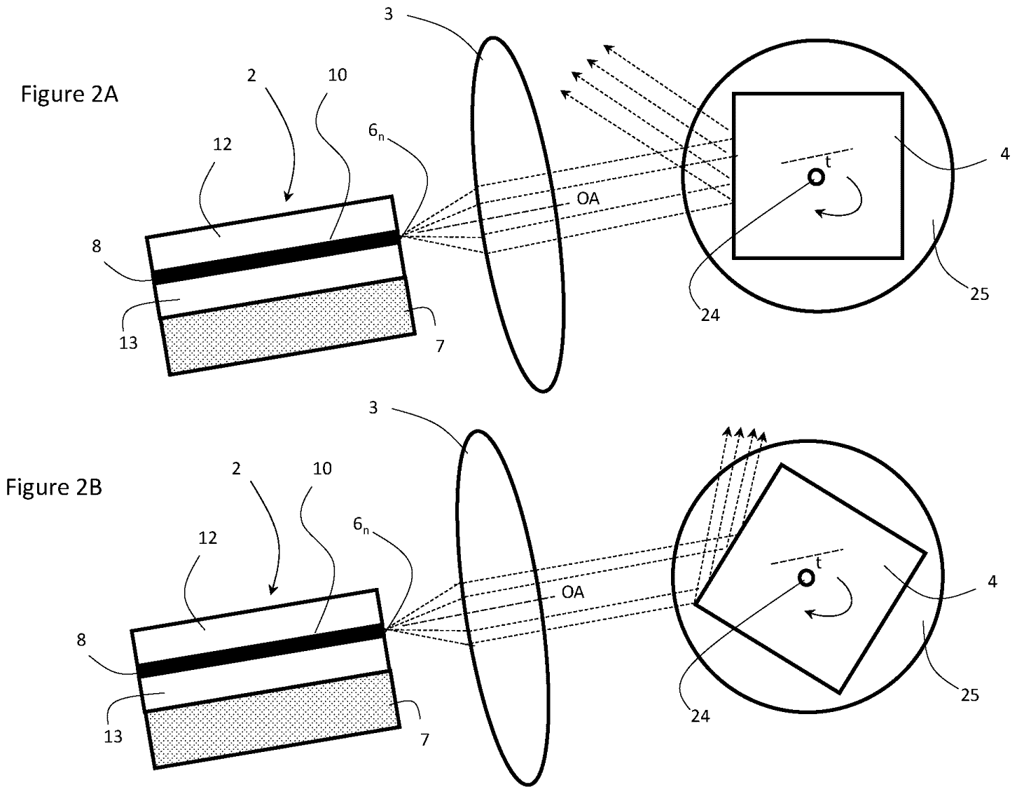

With reference to FIGS. 1, 2A and 2B, an apparatus includes an optical device 1, e.g. LIDAR, which in accordance with an exemplary embodiment comprises: on optical emitter chip 2, a lens system 3, and a rotating reflector, e.g. mirror, 4. For beamforming, one or more highly collimated output beams 5, may be transmitted when a point emitter 6₁ to 6ₙ from the optical emitter chip 2 is placed proximate to or substantially on the focal plane F of the lens system 3 (infinite conjugation). The reverse propagation is also true based on the reciprocity theorem, whereby a parallel input beam 5ᵢ, e.g. one of the output beams 5ₒ reflected off of an object, shining on the lens system 3 will focus at a point spot to be captured by one of the point emitters 6₁ to 6ₙ, with a slight spread determined by lens aberration and diffraction. For beam-steering, the far-field beam angle a of the shaped, e.g. substantially collimated or focused, output beam 5, depends on the location of the point emitter 6₁ to 6ₙ on the focal plane F relative to the longitudinal central optical axis OA of the lens system 3. The beam angle a is governed by the equation: α=arctan(d/f), where d is the distance from the center of the focal plane, i.e. the point where the optical axis OA coincides with the focal plane F, and f is the focal length of the lens system 3. Therefore, a full LIDAR system may be implemented by placing the optical emitter chip 2 of point emitters 6₁ to 6ₙ on or near the focal plane F of the lens system 3, then using a controller processor 20, selectively switch on and off selected and unselected point emitters 6₁ to 6ₙ, respectively, to steer the one or more output beams 5ₒ in the desired directions at the desired beam angles a. This method is fundamentally different than optical phased arrays as the relative optical phase between the emitters does not need to be controlled, and only one point emitter 6₁ to 6ₙ may be turned on at a time. Moreover, a plurality of point emitters 6₁ to 6ₙ may be activated simultaneously or sequentially by the controller processor 20 for transmitting multiple output beams 5ₒ pointing in different directions, i.e. at different beam angles α₁ to αₙ.

The optical emitter chip 2 may include: a main substrate 7 for supporting an optical waveguide structure, including an optical emitter array 10 comprising a plurality of optical waveguide cores 8 surrounded by cladding, each optical waveguide core 8 comprising a main optical waveguide core coupled to and ending with one of the point emitters 6₁ to 6ₙ. Ideally, the point emitters 6₁ to 6ₙ are arranged into an array of point emitters 6₁ to 6ₙ comprising a column (or row) of aligned point emitters 6₁ to 6ₙ. Preferably, the point emitters 6₁ to 6ₙ comprise end-fire tapers 9. The optical emitter chip 2 may include the optical waveguide structure, comprised of one or more optical waveguide layers configured to form the optical waveguide cores 8 with the end-fire tapers 9 coupled at outer ends thereof, all surrounded by cladding, i.e. a material with a lower index of refraction. As seen in FIGS. 2A and 2B, the optical emitter array 10 including the point emitters 6₁ to 6ₙ, the optical waveguide cores 8 and the end-fire tapers 9 may be coplanar with the optical axis OA of the lens system 3. The optical waveguide cores 8 and the end-fire tapers 9 may comprise silicon (Si) or silicon nitride (SiN), or both Si and SiN or any other suitable optical waveguide core material. The optical waveguide structure may be mounted on, e.g. grown on top of, the main substrate 7 with upper and lower cladding 12 and 13 surrounding the optical waveguide cores 8 and the end-fire tapers 9. The upper and lower cladding 12 and 13 may be comprised of on oxide material, such as silicon dioxide (SiO₂), e.g. 2-5 μm thick, and the main substrate 7 may be comprised of silicon, quartz or any suitable material. At least some of the end-fire tapers 9 may be between 25 μm and 400 μm in length and taper down, e.g. by 25% to 75%, preferably by about 50%, from the original width of the optical waveguide core 8, e.g. between 400 nm and 500 nm wide by between 200 nm and 250 nm thick, to a tip with a width of between 100 nm and 400 nm and the original thickness, e.g. between 200 nm and 250 nm, although the thickness may also be tapered to less than the optical waveguide core 8, if required. Preferably, the end of the end-fire tapers 9 may be symmetrical, e.g. square (200 nm×200 nm), to ensure that the TE and TM modes are substantially the same size at the end-fire tapers. At least some of the end-fire tapers 9, e.g. point emitter 65, may comprise reverse tapers, which expand, at least in width, from the original dimensions, e.g. width, of the optical waveguide core 8 to a wider width, e.g. 2× to 10× wider or to between 1 μm and 4 μm in width. The thickness may also expand, if required. Some of the end fire tapers 9 may be narrowing in width and some of the end fire tapers 9 may be widening in width. Some of the end fire tapers 9 may narrow more or less than other end fire tapers 9, and some of the end fire tapers 9 may widen more or less than the other end fire tapers 9.

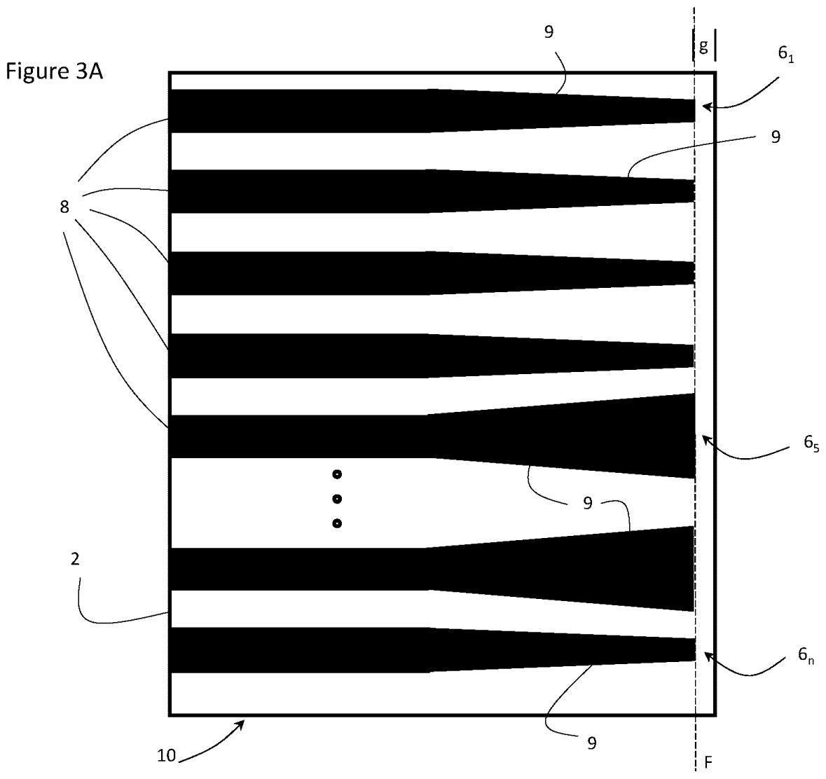

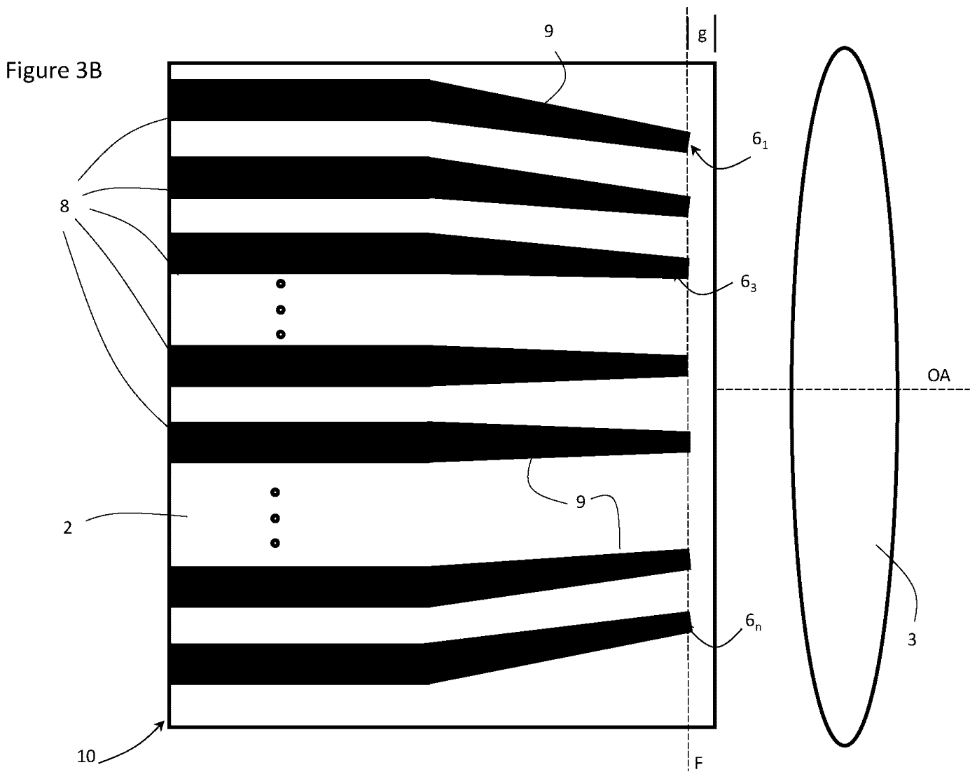

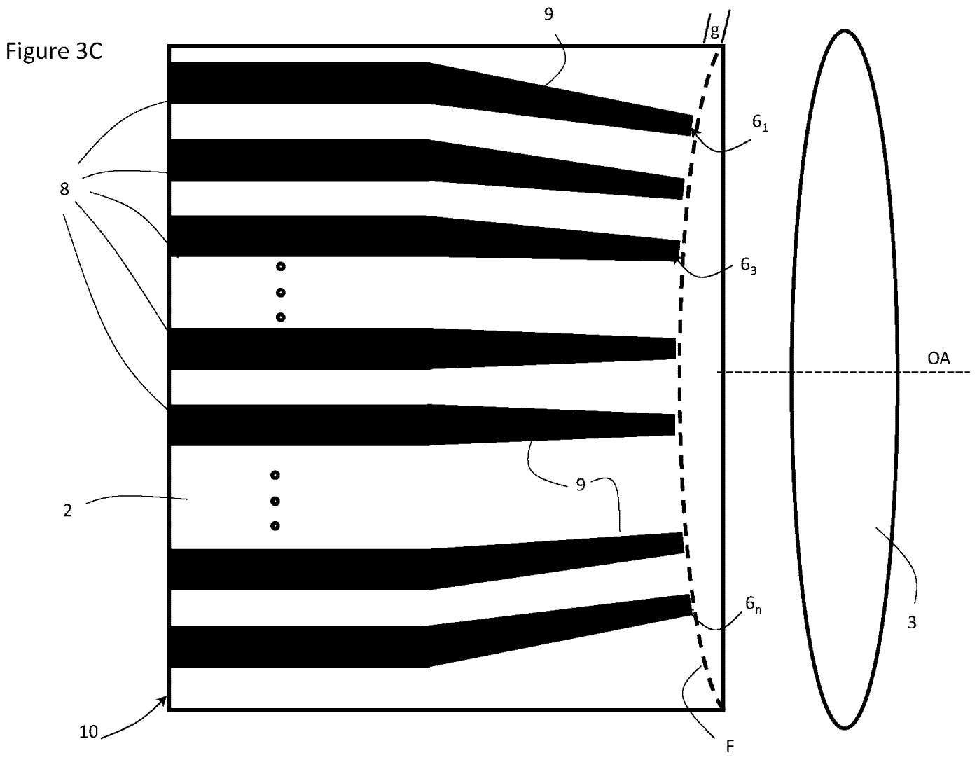

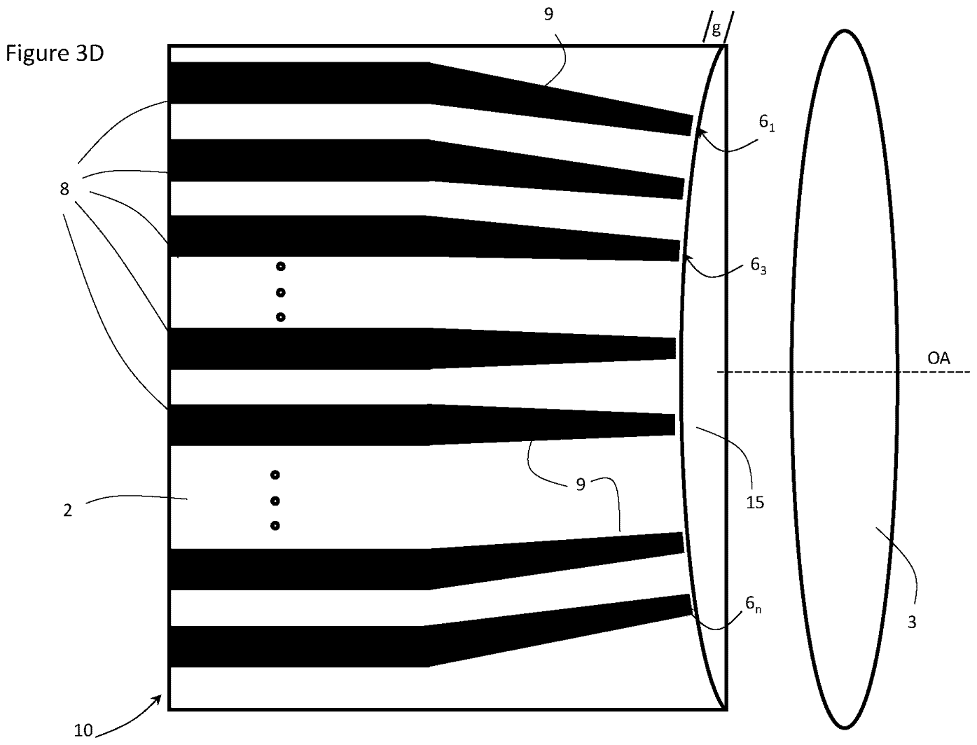

With reference to FIGS. 3A to 3D, there may be a small gap g comprising the same material as the cladding between the edge of the optical emitter chip 2 and the end of each end-fire taper 9. The gap g may be 0 nm up to 5 μm, preferably 500 nm to 1 μm. The gap g may be the same or different for some or all of the end-fire tapers 9. With reference to FIG. 3B, some of the end-fire tapers 9 may be configured to extend and terminate at an acute angle to the waveguide core 8 and/or a longitudinal central axis of the optical emitter chip 2, and/or the optical axis OA of the lens system 3. In other words, a longitudinal axis of the end-fire taper 9 is disposed at an acute angle relative to a longitudinal axis of the waveguide core 8 and/or the optical axis OA of the lens system 3. In this way, the chief ray of the light emitted from the end-fire taper 9 towards the lens system 3, or focused from the lens system 3 to the end-fire taper 9, may be tilted from the optical axis OA, i.e. the lens system 3 does not need to be image-space telecentric. Such a property may greatly simplify the design of the lens system 3.

Ideally, some or all of the end-fire tapers 9 are disposed at an acute angle such that the light emitted from the end-fire tapers 9 into free space is parallel to the designed chief ray angle of the lens system 3 at the location in the image plane corresponding to the end-fire taper 9. Some of the end-fire tapers 9 may be configured to extend substantially towards the optical axis OA and/or the longitudinal central axis of the optical emitter chip 2, i.e. the optical emitter array 10. Some of the end-fire tapers 9 may extend at a greater acute angle than other end-fire tapers 9. Preferably, the farther from the optical axis OA of the lens system 3 the greater the acute angle. Accordingly, the gap g may be varying in length along the array of end-fire tapers 9. The ends of each end-fire taper 9 may extend to the same distance from the edge of the optical emitter chip 2, i.e. the same gap length g, whereby each point emitter 6₁ to 6ₙ is substantially along or proximate to a straight focal plane F. Accordingly, some of the end-fire tapers 9 may have a different length than other end-fire tapers 9, and in particular, the end-fire tapers 9 at the outer edges of the optical emitter chip 2 are longer than the end-fire tapers 9 in the middle of the optical emitter chip 2, and/or the end fire tapers 9 gradually increase in length starting with shorter end-fire tapers 9 in the middle of the optical emitter chip 2, e.g. along the longitudinal central axis of the optical emitter chip 2 and/or the optical axis OA of the lens system 3, and ending at the outer end-fire tapers 9 with longer end-fire tapers 9. Alternatively, the end-fire tapers 9 may be made all the same length, but the main optical waveguide cores 8 extended differing lengths to accommodate the differing gaps g between the end-fire tapers 9 and the edge of the optical emitter chip 2. The optical waveguide cores 8 and the end-fire tapers 9 may also be joined by a gradual bend rather than a sharp transition. In some embodiments the differing gap length g may be accommodated by differing radii or lengths of these gradual bends. The ends of the end-fire tapers 9 may be perpendicular to the edge of the optical emitter chip 2 and/or perpendicular to the longitudinal central axis of the end-fire taper 9.

With reference to FIGS. 3C and 3D, some or all of the end-fire tapers 9 may be disposed such that each point emitter 6₁ through 6ₙ is substantially along or proximate to a curved focal plane F, corresponding to the curved focal plane F of the lens system 3. This curved focal plane F may be approximately spherical, corresponding to a non-zero Petzval sum of the lens system 3, or may be aspheric. The lens system 3 and shape of the focal plane F optimally may be co-designed such that the curvature of the focal plane F can help to reduce optical aberrations in the lens system 3 or simplify its design, e.g. allow the lens system 3 to comprise fewer elements.

With reference to FIG. 3D, the edge of the optical emitter chip 2 may be further etched down to form a trench 15, a substantially curved edge of which may be substantially along or parallel to the curved focal plane F, with the end-fire tapers 9 ending proximate to the edge of the curved trench 15, e.g. with the gap g therebetween. The ends of each end-fire taper 9 may extend to a same distance from the edge of the optical emitter chip 2, i.e. the same gap length g, whereby each point emitter 6₁ to 6ₙ is substantially along or proximate to the curved focal plane F. The trench 15 may also be fully etched away through the upper cladding 12 and the lower cladding 13, and optionally the substrate 7, if necessary, to avoid the light coming out of the end-fire tapers 9 hitting the bottom surface of the trench 15, e.g. when the curve of the trench 15 has a large sagitta. Alternatively, the trench 15 may be partially etched and the substrate 7 thinned from the back until no material remains in the area defined by the trench 15. For sufficiently small sagitta, a partial etch of the trench 15 alone may be sufficient. The ends of the end-fire tapers 9 may be directed, i.e. the longitudinal central axis thereof may be, substantially perpendicular or at an acute angle to the tangent of the edge of the trench 15. The edge of the trench 15 may be curved, e.g. collinear or parallel to the curved focal plane F, or include a series of steps, e.g. one step for each point emitter 6₁ to 6ₙ. Accordingly, the gap g of the cladding material, i.e. between the end of the end-fire taper 9 and the curved trench 15, may again have substantially the same length of cladding material for each end-fire taper 9.

With reference to FIGS. 3A through 3D, which illustrates a section of the optical emitter array 10 on the optical emitter chip 2, the positions of the point emitters 6₁ through 6ₙ may be spaced regularly, i.e. a same distance apart, or irregularly, i.e. different distances apart, along the direction perpendicular to the optical axis OA or the edge of the optical emitter chip 2. The position of the point emitters 6₁ to 6ₙ with respect to the optical axis OA, combined with the design, i.e. focal length, of the lens system 3, sets the beam angle α of the output beam 5, leaving the lens system 3 and travelling into free space. In some embodiments, the point emitters 6₁ to 6ₙ, i.e. the end-fire tapers 9, may be deliberately spaced irregularly to address a non-uniform family of angles with the output beams 5ₒ. In some embodiments, the lens system 3 may have distortions such that a regular spacing of point emitters 6₁ to 6ₙ may create an irregular angular spacing of the output beams 5ₒ. To compensate for such distortions, the spacing of the point emitters 6₁ to 6ₙ i.e. the end-fire tapers 9, may be varied and made irregular in the opposite direction so that the angular spacing is substantially uniform leaving the lens system 3.

One or more of the modifications to the end-fire tapers 9 and facet design described above may be combined in a single embodiment. Particularly, a layout of the point emitters 6₁ to 6ₙ that allows for focal plane curvature, arbitrary chief ray angle, and corrected distortion significantly relieves constraints on the design of the lens system 3, and may allow it to be constructed of a single element, even at low f-number.

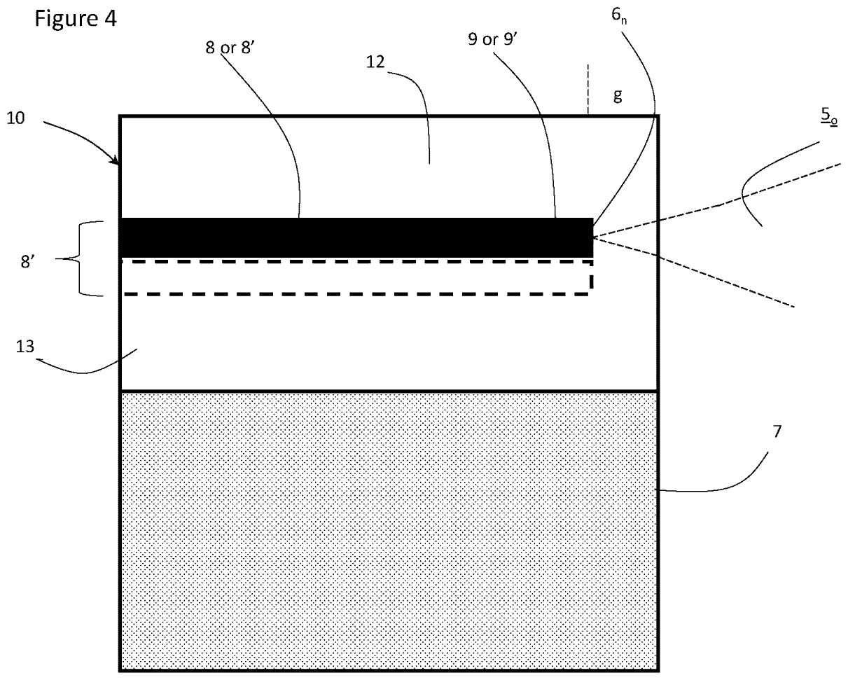

FIG. 4 illustrates a cross section of the optical emitter chip 2, i.e. showing one of the point emitters 6ₙ in the optical emitter array 10. The array of point emitters 6₁ to 6ₙ may include some or all of the optical waveguide cores 8 comprised of one or two optical waveguide layers configured to form singular or bi-layer optical waveguide cores 8 or 8′, respectively, and singular or bi-layer end-fire tapers 9 or 9′, respectively. Including a second layer of optical waveguide core material enables mode profile engineering that may also enable modification of the NA of the point emitters 6₁-6ₙ, i.e. launching light into a coupled mode that has a broader mode spread results in a smaller NA. The bi-layer optical waveguide cores 8′ and the bi-layer end-fire tapers 9′ may be comprised of two similar optical waveguide core materials with similar indexes of refraction, e.g. both silicon (Si) or both silicon nitride (SiN), or of two different optical waveguide core materials with different indexes of refraction, such as a first index of refraction, e.g. Si, larger than a second index of refraction, e.g. SiN, or any other suitable optical waveguide core material. The optical waveguide cores 8 or 8′ may be mounted on, e.g. grown on top of, the main substrate 7 with upper and lower cladding 12 and 13 surrounding and between the dual optical waveguide cores 8′ and end-fire tapers 9′. The upper and lower cladding 12 and 13 may be comprised of on oxide material, such as silicon dioxide (SiO₂), e.g. about 2-4 μm thick, preferably about 3 μm thick, and the main substrate 7 may be comprised of silicon or any suitable material.

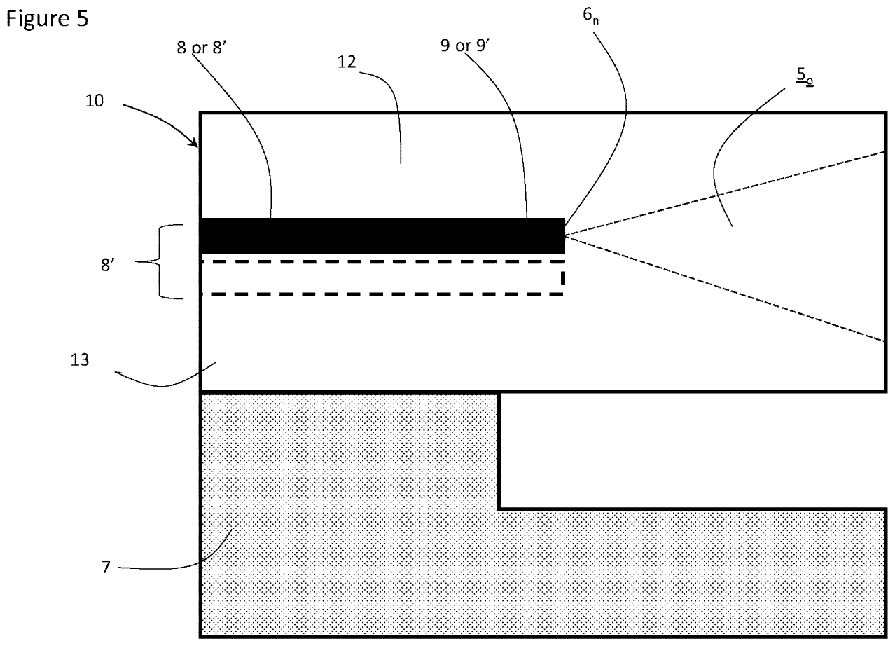

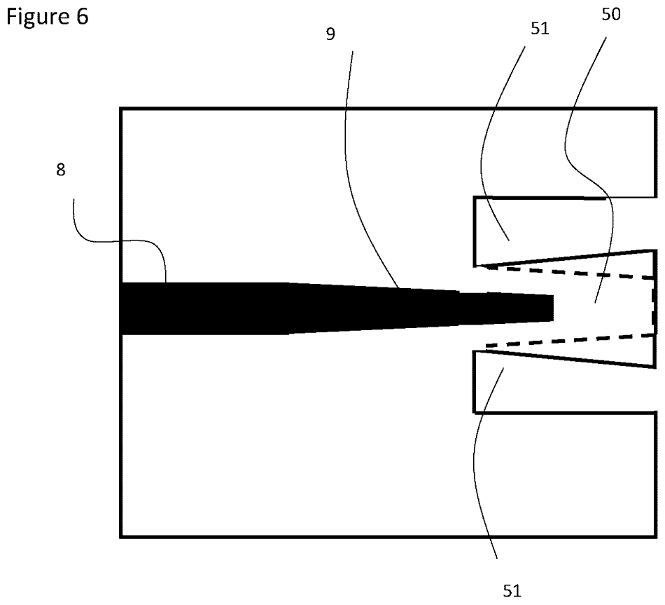

With reference to FIGS. 5 and 6, to further reduce the NA of the point emitters 6₁ to 6ₙ, a suspended optical waveguide structure 50 may be provided optically coupled to the end of some or each of the end-fire tapers 9 or 9′. The suspended optical waveguide structure 50 may be comprised of the cladding material, e.g. SiO₂, now forming the optical waveguide core, surrounded by a pocket of material with a lower index of refraction, e.g. air, forming cladding. The suspended optical waveguide structure 50 may be suspended above the main substrate 7 by removing, e.g. etching, one or more of the substrate material from the main substrate 7 and/or the cladding material from the upper and lower cladding 12 and 13 beneath and/or around the suspended optical waveguide structure 50 forming a pocket or chamber 51 around the suspended optical waveguide structure 50. Accordingly, the NA for suspended waveguide structure 50/end-fire tapers 9 or 9′ may be reduced to less than about 0.25, preferably less than about 0.2. The suspended optical waveguide structure 50 may extend about 2 μm to 50 μm into the chamber 51, whereas the end fire taper 9 or 9′ may extend somewhat into the chamber 51, but less than the full length of the suspended optical waveguide structure 50. The suspended optical waveguide structure 50 may have a thickness, e.g. about 6 μm to 8 μm, the same as the total optical emitter array 10, or may be made thinner than the optical emitter array 10 by the local removal of some of the upper cladding 12. The suspended optical waveguide structure 50 may have a constant width about the same as the thickness, e.g. about 6 μm to 8 μm. The suspended optical waveguide structure 50 may include tapering side and/or upper and/or lower walls, i.e. narrowing width and/or height towards the outer free end thereof (dashed lines) or may include reverse tapering side and/or upper and/or lower walls, i.e. widening width and/or height towards the outer free end thereof, i.e. along a light transmission direction. Ideally, the end-fire taper 9 or 9′ is positioned in the center both vertically and horizontally of the waveguide structure 50.

The lens system 3 may comprise a plurality of lens elements, if required. Most of the design of the lens system 3 is a compromise between the F-number, the field-of-view, and the aperture size. However, there may be a few design priorities: e.g. a) to have an image-plane telecentric design, where the chief rays from the point emitters 6₁ to 6ₙ are all parallel to the optical axis OA in the image space, b) reaching diffraction limit across the field-of-view, and c) the image space numerical aperture (NA) of the lens system 3 substantially matches or exceeds the NA of the point emitters 6₁ to 6ₙ. Minimizing the effect of lens curvature aberrations enables the smallest spread in the output beams 5, and the best possible focusing for the receiving input beams 5ᵢ. The point emitters 61 to 6, preferably emit output beams 5, at a beam angle that may be fully captured and transmitted by the lens system 3. For example, if the NA of one or more of the point emitters 6₁ to 6ₙ is larger than the image space NA of the lens system 3, then a portion of the light emitting from the point emitters 6₁ to 6ₙ will not transmit through the lens system 3, therefore rendered as loss.

The optical device I may also include at least one light source, preferably an array of light sources, and at least one photodetector, preferably an array of photodetectors optically coupled to corresponding one or more point emitters 6₁ to 6ₙ in the optical emitter chip 2. Preferably, the array of light sources and the array of light detectors comprises an array of transceivers 11₁ to 11ₙ. Each transceiver 11₁ to 11ₙ may comprise a light source, e.g. laser, which generates at least one of the output beams 5ₒ and one or more photodetectors, which detects at least one of the input beams 5ᵢ. Selectively sending and receiving light to and from the point emitters 6₁ to 6ₙ may be provided by a switching matrix 16 between the transceivers 11₁ to 11ₙ and the point emitters 6₁ to 6ₙ. Accordingly, to select a desired point emitter 6₁ to 6ₙ, corresponding to a desired beam angle a, the controller processor 20 may select one or more of the light sources in one of the transceivers 111 to 1 In, corresponding to one or more of the point emitters 6₁ to 6ₙ, in that row or column by turning on and/or off various switches 14 in the switching matrix 16. For example, with four point emitters 6₁ to 6₄ (m=4) in the row or column of point emitters 6₁ to 6ₙ, connected to the first transceiver 11₁, the switching matrix 16 may have a single input port optically coupling the first transceiver 11₁ to a first switch tree comprising (m-1=3) switches 14, e.g. 2+2 on-chip Mach-Zehnder interferometers (MZI), which can be selectively activated by the controller processor 20 to output the output beam 5ₒ to a desired output port. Any number of branches and switches 14 in the first switch tree, including direct coupling from each transceiver 111 to each point emitter 6₁ to 6ₙ, is possible. A plurality of optical waveguide cores 8 extend parallel to each other between the output ports of the switching matrix 16 and the point emitters 6₁ to 6ₙ. Ideally, the pitch of the point emitters 6₁ to 6ₙ in the optical emitter chip 2 is 5 μm to 1000 μm or based on the focal length f, size L of the optical emitter array 10 and the angular resolution required by the LIDAR system:

$$Pitch = resolution / ( 2 * arctan ( L / 2 f ) ) * L$$

Similarly, when one of the incoming beams 5ᵢ is received at the same point emitter 6₁ to 6ₙ, the incoming beam 5ᵢ is transmitted in reverse via the corresponding optical waveguide core 8 to the switching matrix 16 back to the corresponding photodetector in the corresponding transceiver 11₁ to 11ₙ.

The optical emitter chip 2 may comprise any one or more of the n optical transceivers 11₁ to 11ₙ, the switching matrix 16, and the array of point emitters 6₁ to 6ₙ; however, any one or more of the n optical transceivers 11₁ to 11ₙ, and the switching matrix 16 may be on separate chips. At any instance, the laser output from one of the optical transceivers 11₁ to 11ₙ is routed to a specific end-fire taper 9 ending at near the edge of the optical emitter chip 2. Each point emitter 6₁ to 6ₙ, i.e. each end-fire taper 9, is configured to emit an output beams 5ₒ out of the edge of the optical emitter chip 2, after which each output beam 5ₒ expands and is directed towards the lens system 3. The edge of the optical emitter chip 2 is aligned on or near the focal plane F of the lens system 3, therefore the output beams 5ₒ, expanding from the end-fire taper 9, will be shaped, e.g. collimated, by the lens system 3 and then emitted to the far field. The far field angle of the output beams 5ₒ depends on the location of the point emitter 6₁ to 6ₙ relative to the optical axis OA of the lens system 3, therefore providing a one dimensional scanning of beams by selectively turning on each point emitters or multiple point emitters at the same time, e.g. depending on how many optical transceiver 11₁ to 11ₙ.

The second axis of the scan is provided by the rotating mirror 4. The output beam 5ₒ coming out of the lens system 3 hits one of the reflective surfaces or facets of the rotating mirror 4 and is redirected into the far field for object detection. The input beam 5ᵢ. corresponding to the output beam 5ₒ reflected from the object, may return via the same reflective surface and the lens system 3 to the originating point emitter 6₁ to 6ₙ for capture by the corresponding photodetector, prior to the rotating mirror 4 rotating out of range, i.e. rotating enough to not be able to direct the corresponding input beam 5ᵢ substantially back to the same originating point emitter 6₁ to 6ₙ as the output beam 5ₒ in a round trip period, e.g. 0.5 ns to 5 μs for an object 7.5 cm to 750 m away. Typically, an output beam 5ₒ is launched by one of the light sources every 2 μs to 1000 μs. In other words, the optical device 1 chirps at about 1 kHz to 500 kHz, i.e. the output beam 5ₒ (continuous or pulsed) is launched every 2 μs to 1 ms.

For each round trip period, some or all of the point emitters 6₁ to 6ₙ may emit an output beam 5ₒ forming a plurality of beams of light in a same detection plane, but at different beam angles a covering an angular detection range, e.g. 10° to 90°. Each light source, e.g. each transceiver 11₁ to 11ₘ, may transmit a beam of light which is separated into sub-beams, e.g. 2-8 sub-beams, by the switching matrix 16, i.e. when all switches 14 are off or omitted entirely, and transmitting light to every waveguide core 8, which are then simultaneously transmitted by the point emitters 6₁ to 6ₙ.

To reduce the number of light sources and photodetectors required, while maintaining a maximum or desired threshold optical power, the controller processor 20 may also cycle through a group of the point emitters, e.g. 6₁ to 6₄, which are optically coupled to one of the transceivers, e.g. transceiver 11₁, by turning selected switches 14 on and off to sequentially transmit a different output beam 5ₒ to each of the point emitters, e.g. 6₁ to 6₄, in the group. Some or all of the light sources, e.g. some or all of the transceivers 11₁ to 11ₘ, may have a different group of waveguide cores 8 optically coupled thereto, whereby a first subset of output beams 5ₒ may be transmitted simultaneously at a time, i.e. one output beam 5ₒ from each light source transmitted via one of the group of waveguide cores 8 coupled thereto. Then, under control of the controller processor 20, each light source will sequentially cycle through each of the waveguide cores 8 in the corresponding group of waveguide cores 8 coupled thereto, spending at least a single round trip period switched to each emitter, e.g. 6ᵢ-6₄. The round trip period should be at least as long as the time necessary for the light to travel from the light source of the point emitter, e.g. 6₁ to 6₄, to the target and back to the photodetector of the point emitter, e.g. 6₁ to 6₄. Accordingly, only a portion of the total number of output beams 5ₒ (and the input beams 5ᵢ) to cover the full range of beam angles a may be transmitted at one time. The controller processor 20 may coordinate the light sources, the switching matrix 16, an angular position of the rotating mirror 4, and the photodetectors to transmit and receive each output beam 5, and each input beam 5; sequentially via the first switching matrix 16 and the plurality of first point emitters 6ᵢ-6ₙ.

As the rotating mirror 4 rotates, one or more output beams 5, may then be scanned, i.e. rotated, through a predetermined scanning range, e.g. angle, depending on the number of facets and the size of the facets on the rotating mirror 4. There are ranges of angles for which the output beams 5ₒ (and input beams 5ᵢ) falling on one of the facets of the rotating mirror 4 are not clipped at the edges, and the total optical scanning range is twice that angular range. One can define a duty cycle as the percentage of the full rotation cycle where the output and input beams 5ₒ and 5ᵢ are fully incident on a facet of the rotating mirror 4 without clipping. For example, four facets with a size of 30×30 mm square face provides a scanning range of about 100° with a duty cycle of 60%, and three facets with a size of the same size provides a scanning range of about 120° with a duty cycle of 50%. As the rotating mirror 4 rotates, the angle of each facet relative to the output beams 5ₒ continuously changes through the range of angles between a first minimum angle i.e. directed at a first edge or corner of the rotating mirror 4 redirecting the output beams to one side of the rotating mirror 4 (FIG. 2A), to substantially perpendicular (intermediate angle) after which the output beams 5ₒ are redirected to a far side of the rotating mirror 4, then to a second maximum angle, i.e. directed at a second edge or corner of the rotating mirror 4 (FIG. 2B). After the maximum angle of each facet, the output beams 5ₒ will sequentially hit and be redirected by the subsequent facets, and proceed through the scanning range of angles from the first minimum angle to the intermediate angle to the second maximum angle again for each facet of the rotating mirror 4.

When the output beams 5ₒ are directed at an edge of the rotating mirror 4 between facets, the light may scatter in different directions, accordingly, the controller processor 20 may reduce or eliminate any incorrect readings by one or more error mitigating schemes by coordinating the position of the rotating mirror 4 with the control of the light sources and the photodetectors, such as turning off the light sources and/or the photodetectors in transceivers 11₁ to 11ₙ for a period of time while the output beams 5ₒ are directed at an edge or by simply disregarding any readings from the photodetectors for the period of time while the output beams 5ₒ are directed at an edge.

The rotating mirror 4 may be comprised of a polygonal prism, comprising a plurality, e.g. 3 or 4 or 5 or 6, of facets, each comprising a reflective surface, and with a longitudinal axis of rotation 24, which may or may not be aligned with a rotational axis of a spinning motor 25. The spinning motor 25 may be any type of rotary motor, such as a stepper motor, de motor, or servo motor. The longitudinal axis of rotation 24 may not be aligned to the axis of the spinning motor 25 when the axes are connected with a belt or gear system. The longitudinal axis of rotation 24 of the rotating mirror 4 may be perpendicular to the optical axis OA of the lens system 3 and/or parallel to a first plane in which the emitter array 10 lies. The optical axis OA may lie in a second plane perpendicular to the first plane and perpendicular or normal to the axis of rotation 24.

Direct reflection of the output beam 5, directly back into the point emitter 6₁ to 6ₙ, i.e. the end-fire taper 9, may be prevented, and the field of view (FOV) may be increased, by disposing the longitudinal axis of rotation 24 of the rotating mirror 4 offset, distance t, from the optical axis OA of the lens system 3, i.e. the axis of rotation 24 may not intersect with the optical axis OA. Generally, the unobstructed FOV range begins at a position where the output beam 5ₒ misses the lens system 3 (back reflected) and ends when the output beam 5ₒ begins to clip the edges of the mirror facet.

There may be dead zones, in which no accurate transmit/return measurements are possible, created by the corners of the rotating mirror 4, which depend on the size and number of the facets.

The rotational speed (revolutions per second, or rps) of the rotating mirror 4 depends on the switching scheme; however, the rotational speed may be the same speed as or less than the LIDAR frame rate, i.e. how long it takes to scan the entire scanning range. For example, for 3 frames/second, divided by the number of facets, e.g. 3-6 facets, equals e.g. 1˜0.5 rps. The rotational speed is preferably kept less than a threshold speed, at which errors may occur if the sweep is too fast such that the input beam 5ᵢ does not reflect back to the same point emitter 6₁-6ₙ (or even hitting nothing). Ideally, this means that the motor angular velocity (in degrees per second), e.g. between 1 and 50 rps, or 360 and 18000 degrees per second, is less than the input beam 5; divergence (in degrees), e.g. between 0.2° and 0.002°, divided by the round-trip time for the light to travel from the mirror system 3 to the target and back (in seconds). For example, for a beam divergence of 0.02° and a target 500 m away, the round-trip time would be 3.33 μs, so the mirror would ideally turn more slowly than 0.02 degrees/3.33 μs, i.e. 6000 degrees/s or roughly 17 rps./#facets

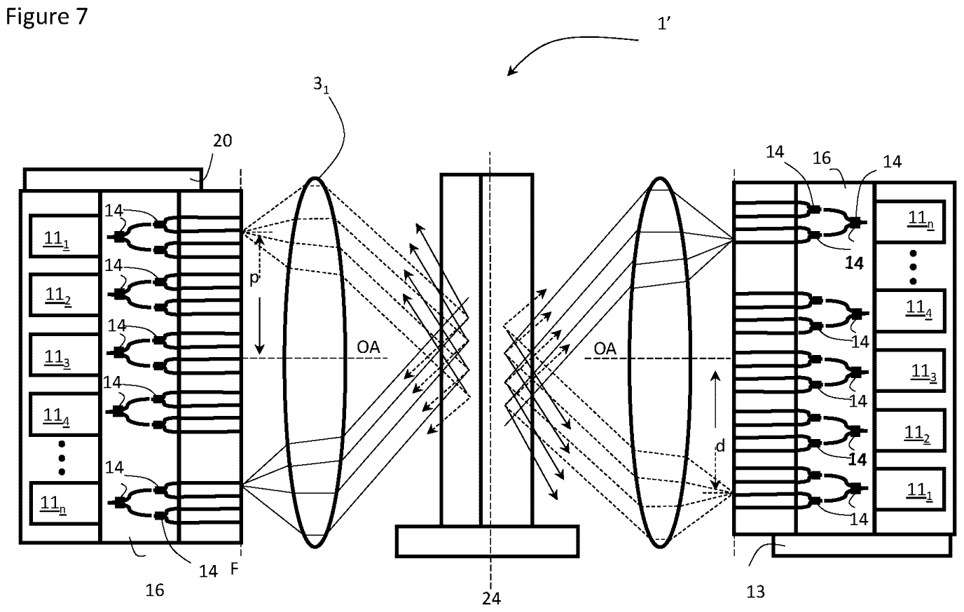

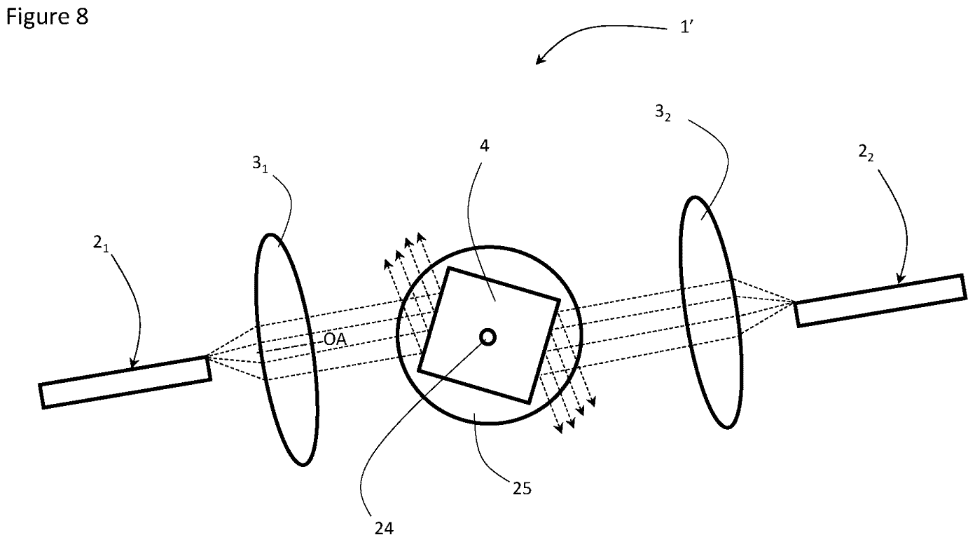

With reference to FIGS. 7 and 8, an exemplary optical emitter device 1′ includes a plurality of optical emitter chips 2₁ to 2ₙ, and corresponding lens systems 3₁ to 3ₙ sharing a single polygonal rotating mirror 4. The benefit of this approach is to expand the field-of-view in one system. A smaller number of facets, e.g. 3 to 6, is desired to keep the volume size of the rotating mirror 4 relatively small.

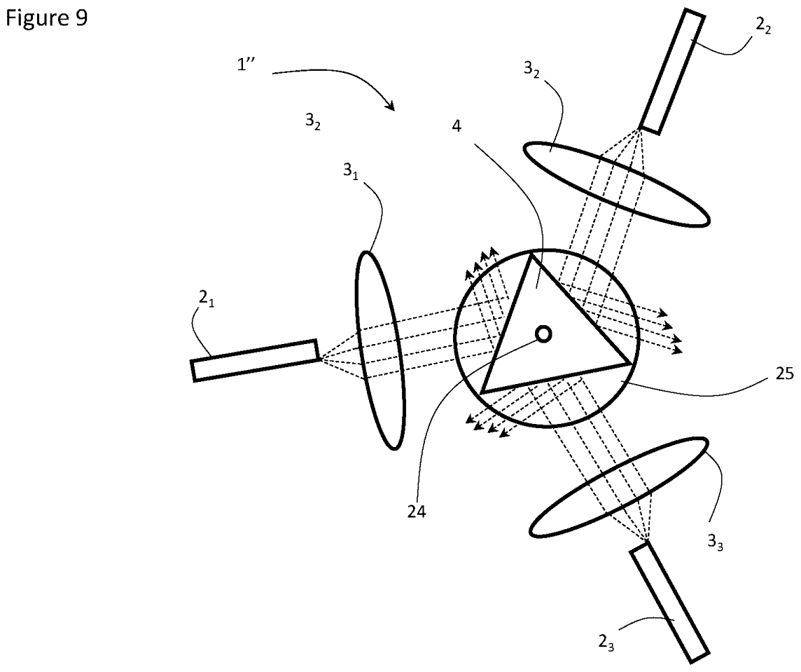

FIG. 9 illustrates an exemplary optical emitter device 1″ in which three sets of optical emitter chips 2₁ to 2ₙ, and corresponding lens systems 3₁ to 3ₙ share a single triangular polygonal reflecting mirror 4.

The term controller or processor may include a microcontroller or a field-programmable-gate-array (FPGA) including with suitable non-transitory memory for storing the control parameters via computer software.

To control the system, when the spinning motor 25 is a stepper motor, the controller 20 may include a dedicated microcontroller or FPGA controller that send control signals, e.g. pulses, to step the spinning (stepper) motor 25 in fixed increments. Therefore, the microcontroller or the FPGA may immediately determine the instantaneous position, i.e. angle, of the rotating mirror 4 based on the control signals. To avoid asynchronized control over time due to the possibly that the spinning (stepper) motor 25 misses steps, an optical slotted interrupter may be installed in the rotating mirror 4/spinning motor 25 system. An interrupt pin may also be installed on either end of rotating mirror 4, which may slide in and out of the optical slotted interrupter thereby temporarily blocking light detection in the optical slotted interrupter as the spinning motor 25 and/or rotating mirror 4 rotates. Therefore, the optical interrupter will provide a pulse signal to the microcontroller/FPGA for every rotation of the rotating mirror 4 and/or the spinning motor 25.

For all types of spinning motors 25, there may be a dedicated rotary encoder either built-in the spinning motor 25 or an external rotary encoder module that provides the absolute or relative angular position of the rotating mirror 4 to the microcontroller/FPGA.

When the controller 20, e.g. the microcontroller/FPGA, has the angular position of the rotating mirror 4, a correct lidar image may be constructed.

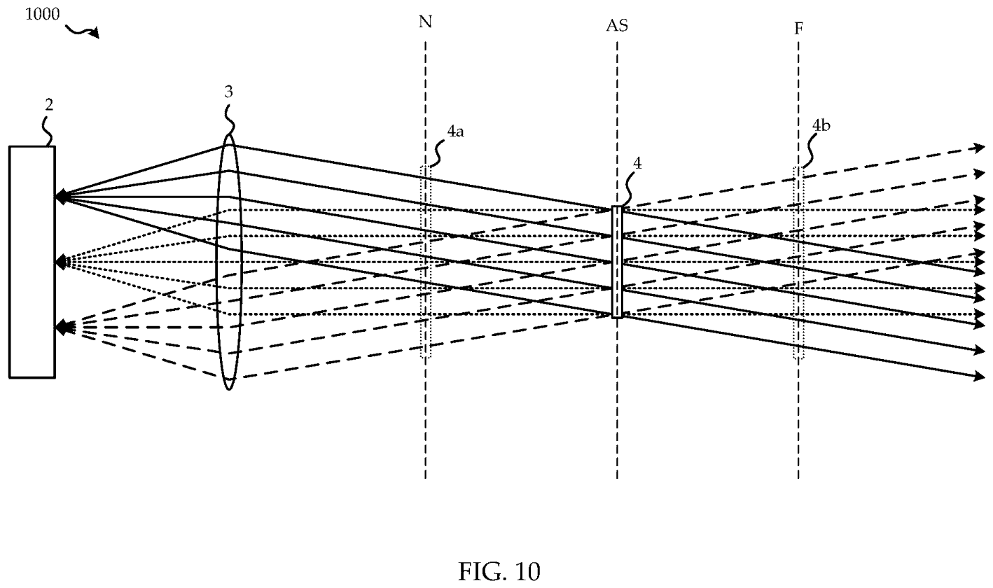

With reference to FIG. 10 another example embodiment of an optical emitter device 1000, comprises the optical emitter chip 2, and the lens system 3, and a rotating or rotationally oscillating reflector, e.g. scan mirror, shown as situated in one of three alternative types of locations. A mirror 4a is illustrated located at a near location N, situated between the lens system and the aperture stop (AS) of the lens system 3, a mirror 4 is illustrated as located at the AS, while a mirror 4b is illustrated located at a far F position, beyond the AS of the lens system 3. The aperture stop AS coincides with the position where the all the output beams of the emitter array of the emitter chip cross after having passed through the lens system 3. Equivalently, it is defined by the smallest 2d cross-section through which all outgoing and incoming light beyond the lens system crosses. It should be noted that such an aperture stop generally exists whether or not the device 1000 is configured to be telecentric or non-telecentric. The optical beams are shown in FIG. 10 unimpeded by any mirror 4, 4a, 4b to compare the size of the cross-section of the beams at the various locations.

The scan mirror may generally be placed anywhere beyond the lens system taking into account the dimensions of the mirror and the desired scanning range which sets limits on how close the rotating or oscillating mirror can be situated relative to the lens system 3. In some embodiments, the lens system is designed to ensure the aperture stop is far enough away from the lens system 3 to accommodate the mirror 4 and where applicable, to also accommodate the associated mounting and driving structures e.g. the motor etc. It should be noted that any of the alternative positions for the mirror nearer than or farther than the aperture stop generally requires a larger reflective surface to reflect all of the outgoing and incoming optical signals, than that required at the aperture stop AS, because everywhere nearer than and farther than the AS the cross-section of the optical beams is larger than the cross-section of the beams at the AS where they cross.

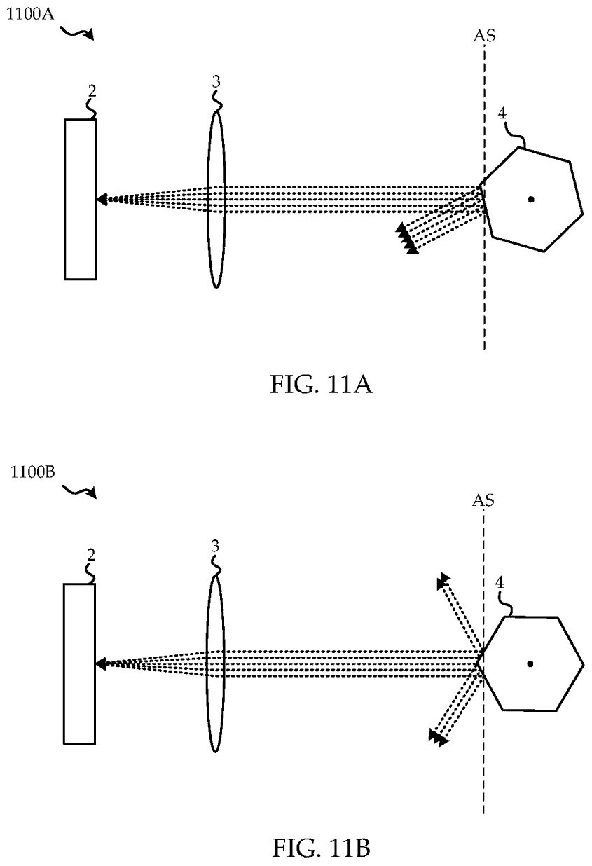

As depicted in FIGS. 11A and 11B, when utilizing a polygonal mirror similar to that described hereinabove, and in particular when utilizing a rotational driving scheme, there will be times during which all of the emitters or pixels of the optical emitter chip 2 are capable of emitting and receiving optical signals via a single facet of the mirror 4, as is shown by the device 1100A in the state illustrated in FIG. 11A. However, there will be times during which various of the emitters or pixels of the optical emitter chip 2 will be directed in different directions by virtue of their encountering different facets of the mirror 4 at once, as is shown by the device 1100B in the state illustrated in FIG. 11B. This state of the device 1100A during the times for which various of the emitters or pixels of the optical emitter chip 2 are be directed in different directions is generally not usable for ranging and detection and is will be referred to herein as dead time. In some embodiments, polygonal or oscillating mirrors are utilized for the horizontal-axis (azimuthal) scanning while an array of emitters or pixels arranged in series parallel to the axis of rotation of the mirror is utilized for vertical-axis (elevational) scanning. In some embodiments the converse is true. Due to the relatively high moment of inertia of a polygonal mirror such as that of FIGS. 11A and 11B, they are generally only driven using continuous rotation at a constant rotational speed.

In some embodiments a polygon scan mirror 4 such as that illustrated in FIGS. 11A and 11B is utilized due to lower costs associated with the continuous rotational driving utilized therewith. In some of those embodiments, although the dead time is appreciable it is utilized for self-testing during which the system does not generate detection and ranging data, but instead simply tests various functions associated with the switches, emitters, or any other aspect of the device capable of self-testing during the dead times.

For numerous reasons, it is advantageous to minimize the moment of inertia of the physical mirror used for scanning (often in a dimension orthogonal to scanning afforded by the multiple emitters of the optical emitter chip 2). A smaller moment of inertia may employ a smaller, lower-torque motor to achieve a certain scanning speed and range. A smaller lower-torque motor reduces cost and power consumption. A smaller moment of inertia can equate to less wear and tear on the motor and related parts and also allows greater relative acceleration, allowing for more agile scan patterns including less time to change scanning rotation direction, which makes nonuniform scanning feasible. Smaller mirrors and motors also make thinner overall LIDAR sensor and device size which may be particularly important in mobile or vehicular applications.

Accordingly, in some embodiments, the mirror size is minimized by placement of its reflective surface (whether a rotating or rotationally oscillating mirror) as close as possible to the aperture stop AS. In some embodiments, in addition to the reflective surface of the mirror being as close to the aperture stop as possible, the axis of rotation of the mirror is also coincident with the aperture stop. Moreover, by also utilizing a thin mirror rather than a polygonal mirror, the advantages of reduced moment of inertia by reduced size and mass are furthered.

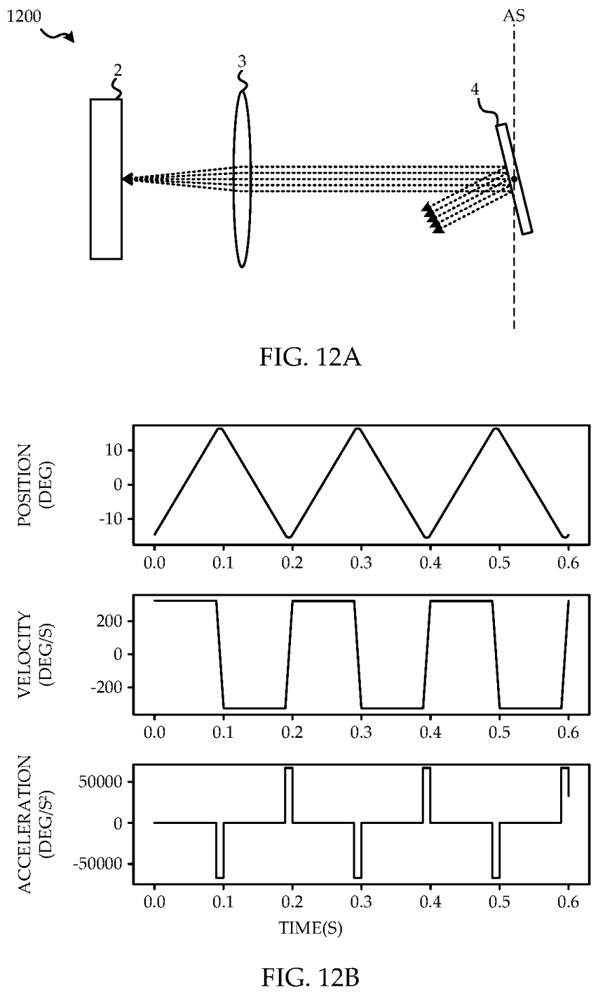

Referring also to FIG. 12A, an oscillating galvo mirror embodiment 1200 will now be discussed. A galvo based embodiment utilizes a galvanometer driven thin mirror 4 located at the aperture stop AS of the lens system 3. A very low moment of inertia for the thin mirror 4 is possible due to a combination of factors including the smallness of the surface area of the mirror by virtue of its placement at the aperture stop, as well as its being thin, both reducing its overall mass. The low moment of inertia in turn makes it practicable to drive the mirror with an oscillating motion which reduces dead time and can be custom tailored for nonuniform scan patterns.

The thin mirror 4 is driven using oscillation which reduces dead time by only rotating the mirror within a limited range which ensures all of the optical power transmitted (and received) by the optical emitter chip is reflected by the surface of the mirror 4. As such, the entirety of the illumination is reflected and utilizable for detection and ranging, and none is discontinuously split-up or otherwise momentarily reflected in unintended directions. Accordingly, there are more useful measurement points per frame (or equivalently points per second) for a fixed laser power compared to devices which drive mirrors in a manner which includes appreciable dead time. This is of particular importance due to laser power being one of the most difficult constraints on the device, including but not limited to, cost, electrical power consumption, and eye safety limits.

It should be noted, however, that dead time is not altogether avoided because oscillating mirrors need to reverse direction at the end of every sweep, and such a reversal cannot be instantaneous. Accordingly, there will a time during which the mirror slows down greatly in transition from rotating in one direction to rotating in the other direction. This turn-around type dead time, can be used to actively image more pixels at the edge of the scanning space, although not particularly useful since the high pixel density during the slow movement corresponds to the edge of the scanning range which is often not the area of focus or highest interest. In some embodiments, the turn-around dead time can be used to run-self tests, for example, to ensure system function and compliance with functional or safety requirements. In some embodiments, turn-around time is 2.5-10 ms at a 5-25 Hz (40-200 ms) frame rate, although turn-around time and frame rate are not necessarily correlated.

Although reference is made above to a galvanometer motor driving the mirror 4, the motor utilized to drive the mirror 4 in an oscillating fashion may be any one of several types, including brushless DC (BLDC) motors and limited-angle torque motors. In some embodiments, mirror control and feedback are utilized for the oscillating motion, and accordingly the motor utilized comprises a rotary encoder which serves to sense and encode an angular position (rotation) of its driving member as part of a feedback loop with the drive signal.

Referring also to FIG. 12B, an example scanning motion imparted to a galvo mirror of an embodiment such as that of FIG. 12A will now be discussed. In a simple mirror scanning pattern, the mirror is driven to oscillate at a constant rate by application of short periods of alternating positive and negative acceleration. As noted above, a rotary encoder as part of a feedback loop ensures the desired oscillation between preset angular positional limits without drift which might otherwise be possible. As shown in FIG. 12B, the mirror is left to rotate freely between short applications of constant torque to impart the angular acceleration during the turn-around dead times.

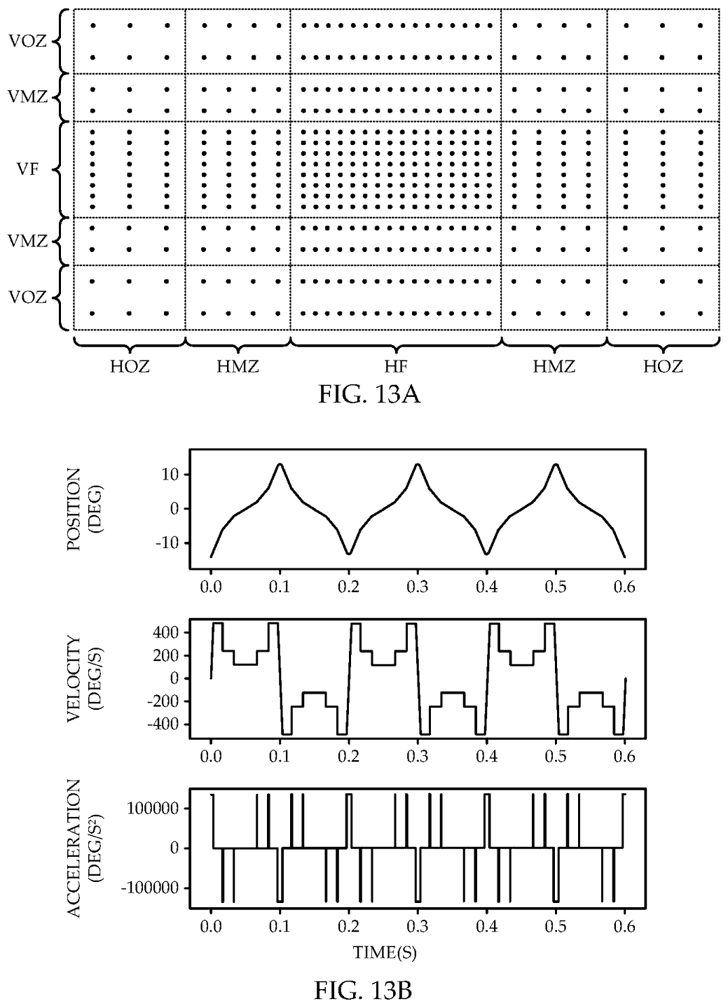

Referring to FIG. 13A, nonuniform scan patterns achievable by low moment of inertia mirrors controlled by an oscillating drive will now be discussed. Depending upon the context and the application of the optical emitter device or deployment of the LIDAR equipment, there may be elevational or azimuthal directions or areas of greater interest. Typically, a device is simply pointed toward such an area, however, with the ability to control the mirror more agilely due its lower moment of inertia, nonuniform scan patterns with areas of greater and lower interest are possible.

In an embodiment where the mirror is controlled to rotate about a vertical axis for horizontal beam scanning, nonuniformity in the horizontal scan is achievable by utilizing a nonuniform velocity in the scanning motion of the mirror. These velocity changes by the mirror are more easily provided the lower the moment of inertia of the mirror, and moreover, the smaller the galvanometer (or other motor) required to drive the mirror, the easier it is to for the motor itself to change its applied torque. As noted above, this is enhanced by placing the mirror and its axis of rotation at the aperture stop AS.

In the example depicted in FIG. 13A, in an area of horizontal focus HF of greatest interest, the mirror can be imparted with a rotational motion which is relatively slow, leading to more scan time and hence more emitter or pixel scans (measurements) per horizontal (azimuthal) angular degree (each measurement represented by a dot in FIG. 13A). In horizontal middle zones HMZ of less interest, the mirror can be imparted with a rotational motion which is faster than that used in the horizontal focus HF, leading to less scan time and hence less emitter or pixel scans (measurements) per horizontal (azimuthal) angular degree. Finally, in horizontal outer zones HOZ of least interest, the mirror can be imparted with a rotational motion which is fastest compared to that used in the other zones, leading to the least amount of scan time and hence least number of emitter or pixel scans (measurements) per horizontal (azimuthal) angular degree. In some embodiments, the nonuniform velocity is programmed live, e.g. on a frame-to-frame basis, either automatically by the device or with user control commands transmitted (e.g. over Ethernet) to the device. In some embodiments, the pixel rate and frame rate are constant, while some embodiments, they are not.

In the example depicted in FIG. 13A, a nonuniform pitch, nonuniform orientation or some combination thereof of the emitters or pixels of the emitter or pixel array of the optical emitter chip 2 determines the vertical nonuniformity of the measurements. In an area of vertical focus VF of greatest interest, the emitters or pixels are positioned or aimed closely, leading to more emitter or pixel scans (measurements) per vertical (elevational) angular degree. In vertical middle zones VMZ of less interest, the emitters or pixels are positioned or aimed less closely, leading to less emitter or pixel scans (measurements) per vertical (elevational) angular degree. Finally, in vertical outer zones VOZ of least interest, the emitters or pixels are positioned or aimed least closely, leading to the least number of emitter or pixel scans (measurements) per vertical (elevational) angular degree.

Referring also to FIG. 13B, an example scanning motion imparted to a galvo mirror of an embodiment generating a scan pattern such as that of FIG. 13A will now be discussed. In a nonuniform mirror scanning pattern, the mirror is driven to oscillate with a number of different constant rates by application of various short periods of positive and negative acceleration. As noted above, a rotary encoder as part of a feedback loop ensures the desired oscillation between angular positional limits without drift which might otherwise be possible. As shown in FIG. 13B, the mirror is left to rotate freely between short applications of constant torque to ensure the mirror rotates slowest over the horizontal focus, faster within the horizontal middle zones, and fastest within the horizontal outer zones. At the end of each oscillation, the outer zone motion is followed by application of the longest period of angular acceleration during the turn-around dead times.

There are various different ways to generate a two dimensional scanning pattern whether uniform or nonuniform (as depicted in FIG. 13A). Generally, measurement along one axis is held stationary or slowly varying while measurement along the other axis occurs quickly over its entirety, prior to being repeated or reversed, resulting in two dimensional coverage. In the case where scanning is a combination of the switching between point emitters or pixels along one dimension (e.g. vertical) and the rotational motion of the mirror for scanning in the other dimension (e.g. horizontal), generally there are two main types of embodiments. In the first type of embodiment, the vertical scan rate resulting from switching emitters or pixels is chosen to be much faster than the horizontal scan rate resulting from the rotation of the mirror. Accordingly, such an embodiment utilizes the emitter chip for the fast-axis. In the second type of embodiment, the vertical scan rate resulting from switching the point emitters or pixels is chosen to be much slower than the horizontal scan rate resulting from the rotation of the mirror. Accordingly, such an embodiment utilizes the emitter chip for the slow-axis.

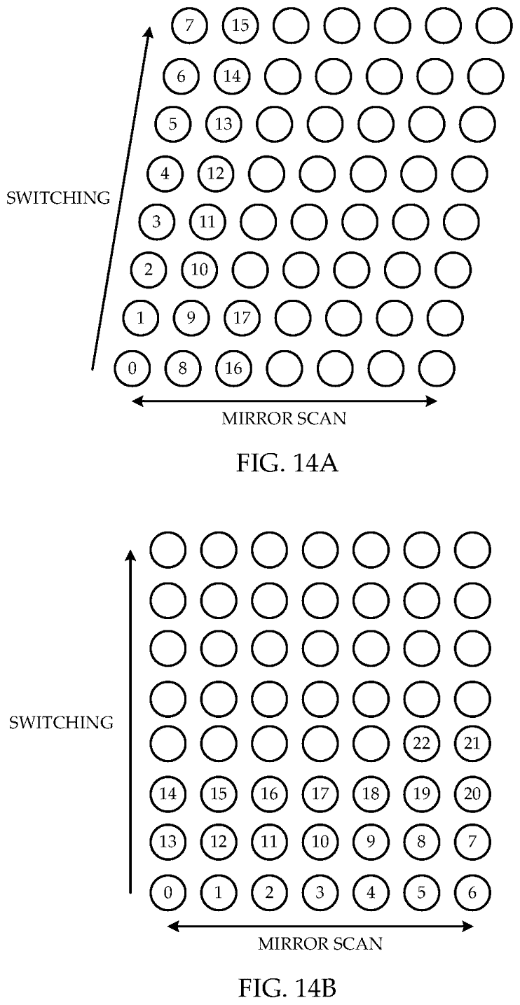

Given modern optical emitter chip technology, using the chip for the fast-axis is often preferred, however, depending upon the context and application sometimes using the chip as the slow-axis is appropriate. FIG. 14A depicts a scanning pattern which uses the chip as the fast-axis. As can be seen the sequence of measurements proceeds over the eight pixels while the mirror scan rotates only a small amount before the eighth measurement is taken at the bottom pixel again during a second frame. In FIG. 14B, a scanning pattern which uses the chip as the slow-axis is depicted. In this sequence, the same point emitter or pixel is scanned or measured multiple times as the mirror rotates in one direction, after seven measurements the mirror reverses direction and thereafter the second pixel is scanned or measured a total of seven times before the mirror reverses direction again.

The foregoing description of one or more example embodiments has been presented for the purposes of illustration and description. It is not intended to be exhaustive or to limit the invention to the precise form disclosed. Many modifications and variations are possible in light of the above teaching. It is intended that the scope of the disclosure be limited not by this detailed description.

We claim:

1. An optical emitter device comprising:
an emitter array comprising a plurality of point emitters, each respective point emitter configured to emit a respective beam of output light, and configured to receive a respective beam of input light;
a lens system configured to shape and direct each respective beam of output light and each respective beam of input light based on a position of each respective point emitter relative to an optical axis of the lens system; and
a rotating reflector located at the aperture stop of the lens system configured to redirect each respective beam of output light outwardly at an angle to the optical axis, and configured to redirect each respective beam of input light towards the emitter array.

2. The optical emitter device according to claim 1, wherein a reflective surface of the rotating reflector is located at the aperture stop.

3. The optical emitter device according to claim 1, wherein an axis of rotation of the rotating reflector and a reflective surface of the rotating reflector are located at the aperture stop.

4. The optical emitter device according to claim 3 further comprising a motor for driving the rotating reflector to repeatedly oscillate, undergoing alternating rotation in one rotational direction and rotation in an opposite rotational direction to the one rotational direction.

5. The optical emitter device according to claim 4, wherein the motor comprises one of a brushless DC motor, a galvanometer motor, and a limited-angle torque motor.

6. The optical emitter device according to claim 4, wherein the motor comprises a rotary encoder for providing feedback to the device for use in a control of said driving.

7. The optical emitter device according to claim 4, wherein the rotating reflector comprises a thin mirror possessing a relatively low moment of inertia.

8. The optical emitter device according to claim 4, wherein during a turn-around dead time while the rotating reflector is accelerated to change direction of rotation between each oscillation, the device performs self-testing.

9. The optical emitter device according to claim 4, wherein the motor is adapted to drive the rotating reflector according to a nonuniform angular scan pattern.

10. The optical emitter device according to claim 9, wherein the nonuniform angular scan pattern includes at least one angular zone of focus, and at least one second angular zone, wherein the motor is configured to drive the rotating reflector to rotate more slowly in each at least one angular zone of focus than in each at least one second angular zone.

11. The optical emitter device according to claim 10, wherein the motor comprises one of a brushless DC motor, a galvanometer motor, and a limited-angle torque motor.

12. The optical emitter device according to claim 10, wherein the rotating reflector comprises a thin mirror possessing a relatively low moment of inertia.

13. The optical emitter device according to claim 10, wherein the plurality of point emitters of the emitter array are arranged such that switching through said point emitter in sequence scans according to an orthogonal nonuniform angular scan pattern which is orthogonal to said nonuniform angular scan pattern of the rotating reflector.

14. The optical emitter device according to claim 13, wherein the optical emitter device utilizes the emitter array as the as the fast-axis.

15. The optical emitter device according to claim 13, wherein the second nonuniform angular scan pattern includes at least one orthogonal angular zone of focus having a first orthogonal angular density of measurement, and at least one second orthogonal angular zone having a higher orthogonal angular density than the first orthogonal angular density.

16. The optical emitter device according to claim 15, wherein the rotating reflector comprises a thin mirror possessing a relatively low moment of inertia.

17. The optical emitter device according to claim 16, wherein the emitter array lies in a first plane substantially parallel to the axis of rotation of the thin mirror.

18. The optical emitter device according to claim 17, wherein the optical axis of the lens system lies in a second plane that is perpendicular to the first plane and normal to the axis of rotation of the rotating reflector.

19. The optical emitter device according to claim 18, wherein during a turn-around dead time while the rotating reflector is accelerated to change direction of rotation between each oscillation, the device performs self-testing.
